(19) United States
(12) Patent Application Publication
(10) Pub. No.: US 2009/0065749 A1
(43) Pub. Date: Mar. 12, 2009

(54) Supporting Structure Capable of Vertically Elevating

(76) Inventors: Chen Hao Wu, Sinjhuang City (TW); Yu-Chen Huang, Sinjhuang City (TW)

Correspondence Address: TROXELL LAW OFFICE PLLC;ONE SKYLINE PLACE, SUITE 1404, 5205 LEESBURG PIKE, FALLS CHURCH, VA, 22041, US

(21) Appl. No.: 12/126,964

(22) Filed: May 26, 2008

(30) Foreign Application Priority Data
Sep. 7, 2007 (TW) 096215006

(51) Int. Cl. B66F 3/08

(52) U.S. Cl. 254/103

(57) ABSTRACT

The present invention relates to a supporting structure capable of vertically elevating, comprises a pair of retracting devices, a base seat and a supporting device; by applying a force to the pair of retracting devices, the elbow joint section disposed at a pivotal connecting location between the top and the bottom rotation sheets is inwardly or outwardly moved, thus the top and the bottom rotation sheets correspondingly close or away from each other, so it can be ensured that the height of the supported objected is vertically adjusted without occupying too much space; and the present invention provides a function of vertically elevating, so problems that a base seat has to be pivotally connected to at the rear portion due to the forward/backward movement of the supported object has overcome and the appearance of the base seat can be styled to enhance the artistic sensation.

### BACKGROUND OF THE INVENTION

1. Field of the Invention

The present invention relates to a supporting structure, more particularly to a supporting structure capable of vertically adjusting height of an object to be supported, e.g. a flat panel monitor.

2. Description of Related Art

Flat panel monitors, e.g. liquid crystal monitors, liquid crystal displays or plasma TVs, have advantages of light in weight, thin and no radiation, etc., and are used to replace conventional CRT monitors. When viewing, the liquid crystal and the plasma monitors have limitations of viewing angles, so a structure of rotation shaft is often provided between the an above mentioned monitor and a base seat for providing a function of adjusting elevation angle of the monitor, with respect to the base seat.

But the described fashion can not provide functions of ascent/descent and forward/backward movement to the flat panel monitors. Auxiliary connecting members disposed in parallel are therefore invented, and two end sections of the two auxiliary connecting members are respectively connected between a main hinge at an upper portion of a connecting member and a base seat hinge at the lower portion of the connecting member. For instance, in the patent, CN 1244852C, granted by China intellectual property office on Mar. 8, 2006 (corresponding to the U.S. Pat. No. 6,822,857) titled in “Monitor improved in a tilting structure”, the elements numbered as 100 and 110 shown in FIG. 5 of the patent are a pair of auxiliary connecting members parallel to each other. And a four-rod linkage mechanism is formed by the pair of auxiliary connecting members, a main hinge and a base seat hinge of the connecting member, so the rotation movement of the connecting member with respect to the base seat member, is converted into a tilt movement of a monitor main body by the auxiliary connecting members. In other words, in order to adjust the height of the monitor main body, while the monitor main body is tilted by the connecting member in an up/down direction, only a second and a third friction springs (sleeve tubes) connected to a main supporting rack rotate around a third and a fourth hinge pins, so when moving, the angle of the monitor main body is remained.

The above patent has disclosed a fashion in which the gradient can be remained regardless the control of height by controlling the gradient, the plane rotation and the height of the monitor main body. The rotation movement of the connecting member, with respect to the base member is in a fan shape, so when adjusting the height of the monitor main body, the movement is not vertical but in a fan shape; a forward/backward movement is thus formed when adjusting the height, this may cause problem that it is difficult to adjust height in a space not large enough for such adjustment.

### SUMMARY OF THE INVENTION

The applicant has devoted himself to design and commercially distribute rotation shafts for years, and want to overcome problems that a forward/backward movement is simultaneously formed with the height adjustment of the above mentioned supporting structure, and wish to develop a novel supporting structure in which the objected to be supported vertically elevates when adjusting the height of the supporting structure without formed a forward/backward movement, so the supporting structure would need less space; after try and error, the present invention “Supporting structure capable of vertically elevating” is therefore provided.

To achieve the objects mentioned above, the present invention provides a supporting structure capable of vertically elevating, comprises a pair of retracting devices that are correspondingly provided, each retracting device is pivotally connected by a pivotal connecting hinge at a location where a bottom end of a top rotation sheet and a top end of a bottom rotation sheet are joined and is pivotally connected by a pivotal connecting hinge, so a elbow joint section is formed at the pivotal connecting location, two ends of the top end of the top rotation sheet and two ends of the bottom end of the bottom rotation sheet are respectively provided with a linking member, each linking member is pivotally connected to a supporting member of a supporting device and a bottom supporting rack of a base seat and is engaged with the other linking members provided at two ends of the top end of the top rotation sheet and two ends of the bottom end of the bottom rotation sheet provided on the other adjacent retracting device so a link is obtained; a base seat having a bottom supporting rack for pivotally connecting the two rotation sheets provided at the bottom end of the pair of retracting devices, and two pairs of linking members disposed thereunder rotate in opposite directions; a supporting device having a supporting member for pivotally connecting the two top rotation sheets provided on the top end of the pair of retracting devices and two pairs of linking members thereon rotate in opposite directions; so when applying a force on the pair of retracting devices, the elbow joint section located at the pivotal connecting location between the top and the bottom rotation sheets can move outwardly or inwardly so that the top and the bottom rotation sheets correspondingly close or away from each other for adjusting height.

### BRIEF DESCRIPTION OF THE DRAWINGS

FIG. 1 is a 3D exploded view of the supporting structure provided by the present invention;

FIG. 2 is a 3D exploded view of the base seat provided by the present invention;

FIG. 3 is a 3D view of the supporting device provided by the present invention;

FIG. 4 is a 3D view of the after-assembled supporting structure provided by the present invention;

FIG. 5 is a cross sectional view of FIG. 4 intercepted alongside an A-A line;

FIG. 6 is a cross sectional view of FIG. 4 intercepted alongside a B-B line;

FIG. 7 is a cross sectional view of FIG. 4 intercepted alongside a C-C line;

FIG. 8 is a 3D view of the after-adjusted supporting structure provided by the present invention.

### DETAILED DESCRIPTION OF THE PREFERRED EMBODIMENT

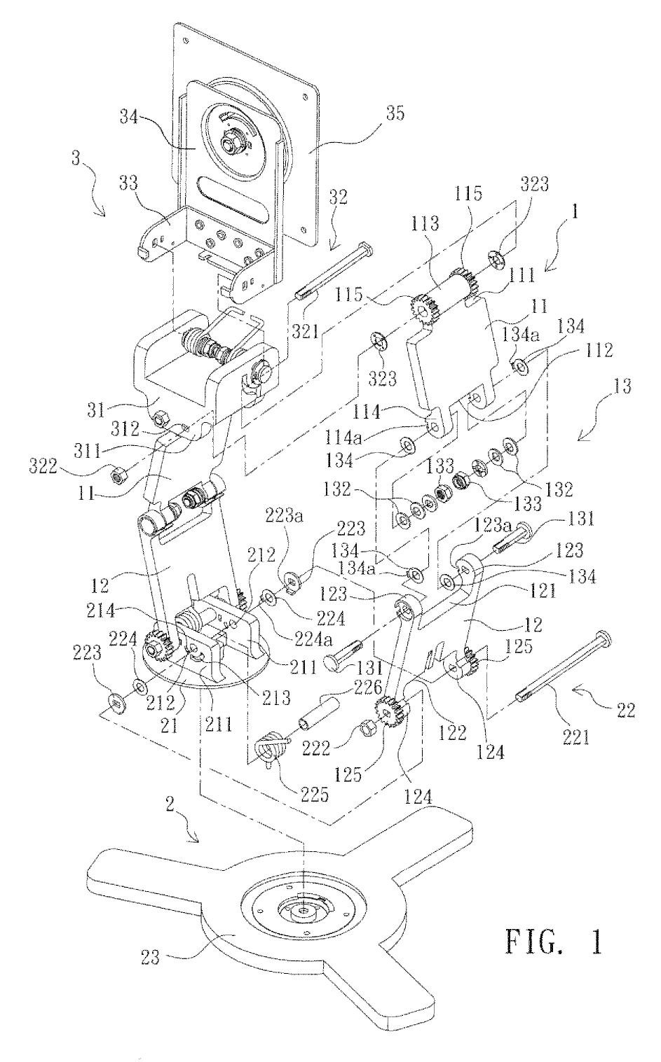

As shown from FIG. 1 to FIG. 4, the supporting structure provided by the present invention is substantially composed by a pair of retracting devices 1, a base seat 2 and a supporting device 3.

The pair of retracting devices 1 is provided between a bottom supporting rack 21 of the base seat 2 and a supporting member 31 of the supporting device 3 so the pair of retracting devices 1 can be stretched or contracted within, so a supported object connected to the supporting device 3 can be adjusted, e.g. a vertical height of a flat panel monitor.

Thereinafter, instead of illustrating the pair of retracting devices 1, only a single retracting device 1 will be illustrated for a better comprehension. As shown in FIG. 1, the retracting device 1 is composed by a top rotation sheet 11, a bottom rotation sheet 12 and a pivotal connecting hinge 13 provided between the top and the bottom rotation sheets 11, 12. The top rotation sheet 11 has a top end 111 and a bottom end 112, the top end 111 and the bottom end 112 are respectively and extrudingly provided with a first top lug 113 and a pair of first bottom lugs 114. In order to link the top rotation sheet 11 of the retracting device 1 with the other top rotation sheet 11 of the other retracting device 1 adjacently provided, two ends of the first top lug 113 are respectively provided with a linking member 115, e.g. a gear, as shown in figures the linking members 15 can be integrally formed at the two ends of the first top lug 113, or each of the linking member 15 can be sleeved and connected by a sleeving member then be mounted to the outer end of the first top lug 113, so the linking members 15 and the first top lugs 113 can be received between two engaging sheets 311 longitudinally and extrudingly provided at the bottom end of the supporting member 31, then a connecting portion of a supporting shaft rod 321 of a supporting hinge 32 is provided and passing through rod holes 312 correspondingly provided on the two engaging sheets 311 and through the two linking members 15 and the first top lug 13, then is connected to an end sealing member 322, e.g. an anti-loosing nut; so the top rotation sheet 11 is pivotally connected to one bottom end of the supporting member 31 and the two linking members 115 of the top end 111 are engaged with the other two linking members 115 disposed at the other top end 111 of the other top rotation sheet 11 thus a link is obtained.

In order to reduce wear of the linking members 15 and the inner walls of the engaging sheets 311, a wear-resistant ring 323 is provided between each of the linking members 15 and the adjacent inner wall of the corresponding engaging sheet 311.

The bottom rotation sheet 12 also has a top end 121 and a bottom end 122. the top end 121 and the bottom end 122 are respectively and extrudingly provided with a pair of second top lugs 123 and a pair of second bottom tugs 124. In order to link the bottom rotation sheet 12 of the retracting device 1 with the other bottom rotation sheet 12 of the other retracting device 1 adjacently provided, the bottom end 122 of the bottom rotation sheet 12, n other words two ends of the two second bottom lugs 124 respectively have a linking member 125, e.g. a gear, as described above the two linking members 125 can be integrally formed at the two ends of the pair of second bottom lugs 124, or each of the linking members 125 is sleeved and connected by a sleeving member then is mounted at the outer end of each of the second bottom lugs 124, so the linking members 125 and the second bottom lugs 124 can be received between two connecting sheets 211 longitudinally and extrudingly provided at the top end of the bottom supporting rack 21, then a connecting section of a supporting rack shaft rod 221 of a supporting rack hinge 22 is provided and passing through rod holes 212 correspondingly provided on the two connecting sheets 211 and through the two linking members 125 and the pair of second bottom lugs 124, then is connected to an end sealing member 222, e.g. an anti-loosing nut, so the base of the bottom rotation sheet 12 is pivotally connected to one bottom end of the bottom supporting rack 21 and the two linking members 125 of the bottom end 122 are engaged with the other two linking members 125 disposed at the other bottom end 122 of the other bottom rotation sheet 12 thus a link is obtained.

In order to limit the rotation angle of the bottom rotation sheet 12, the peripheries of the rod holes 212 of the connecting sheets 211 of the bottom supporting rack 21 for allowing the supporting rack shaft rod 221 pass through are respectively provided with an arc-shaped angle limiting slot 213, and the supporting rack shaft rod 221 is provided with a position limiting sheet 223 linked therewith at each outer end of the two connecting sheets 211, the periphery of each of the two position limiting sheets 223 is axially and extrudingly provided with a tenon 223a that is received within the corresponding angle limiting slot 213, so that each of the bottom rotation sheets 12 is provided with an angle limitation of 0 to about 70 degree from a horizontal contraction status to a tilted stretch status.

In order to reduce wear of each of the position limiting sheets 223 and the connecting sheets 211, a wear-resistant ring 224 is provided between each of the position limiting sheets 223 and the corresponding connecting sheets 211, the periphery of the wear-resistant ring 224 is axially and extrudingly provided with a tenon sheet 224a for mounting into a pre-set tenon hole 214 provided at the periphery of each of the rod holes 212 of each of the connecting sheets 211.

At least one auxiliary torsion spring 225 is provided between the supporting rack shaft rod 221 and the two connecting sheets 211, two ends of the auxiliary torsion spring 225 respectively are propped against the bottom rotation sheet 12 and the bottom supporting rack 21, the auxiliary torsion spring 225 is sleeved at an outer side of a tube strut 226, and the tube strut 226 is served to let the supporting rack shaft rod 221 pass through. The function of the auxiliary torsion spring 225 is to offset weight of an supported object, e.g. a flat panel monitor, against the summed elastic force of the auxiliary torsion spring 225 provided, so only a user can spend a little effort to easily adjust the height of the supported object, in relation to the base seat 2.

The pivotal connecting hinge 13 is provided between the bottom end 112 of the top rotation sheet 11 and the top end 121 of the bottom rotation sheet 12, and the pivotal connecting position thereof is formed as an elbow joint section, so the top rotation sheet 11 can rotate around the pivotal connecting hinge 13, and the torque between the top and the bottom rotation sheets 11, 12 and the pivotal connecting hinge 13 is larger than the weight of the supported object, so that after a mounting plate 35 of the supporting device 3 is connected to the supported object, the pair of retracting devices 1 will not be stressed then collapses due to an external force. As shown in FIG. 1, the bottom end 112 of the top rotation sheet 11 and the top end 121 of the bottom rotation sheet 12 are connected by the two first bottom lugs 114 and the two second top lugs 123 connecting to each other, and the two adjacent lugs 114, 123 are passed through by a connecting section of an interpose rod 131 and the connecting section of the interpose rod 131 is in sequence connected to at least one resilient member 132, e.g. a disc resilient sheet, at the inner side of the first bottom lug 114, then is connected to an end sealing member 133, e.g. an anti-loosing nut, so the top rotation sheet 11 and the bottom rotation sheet 12 can perform fan-liked movement.

In order to reduce wear of the first bottom lug 114 and the adjacent second top lug 123, a wear-resistant ring 134 is provided between the two lugs, and the periphery of the wear-resistant ring 134 is axially and extrudingly provided with a lug sheet 134a for mounting into each pre-set lug slots, 114a, 123a, provided at the periphery of each of the first bottom lug 114 and the second top lug 123.

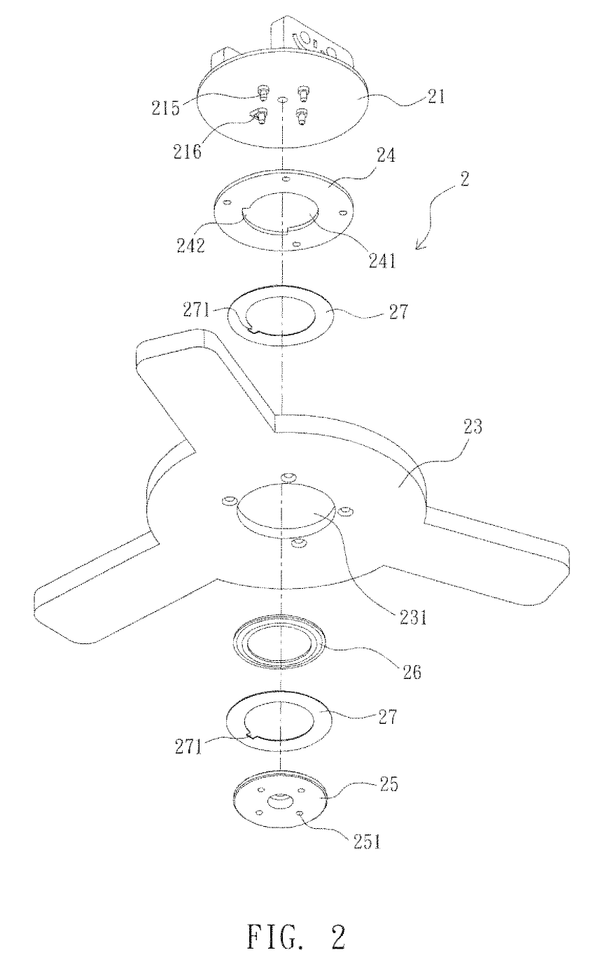

As shown in FIG. 2, the bottom supporting rack 21 is disposed on a bottom seat 23 by the base seat 2, the center of the bottom seat 23 is provided with a multi-stepped through hole 231, a retaining sheet 24 is provided within the through hole 231, and an arc-shaped position limiting slot 242 is outwardly extended from a periphery of a sheet hole 241 disposed at the center of the retaining sheet 24, and a plurality of convex tenons 215 are provided on the base plane of the bottom supporting rack 21 and the convex tenons 215 are served to pass through the sheet hole 241 of the retaining sheet 24 and are combined with tenon holes 251 pre-set on a bottom cover 25 within the through hole 231, e.g. a rivet, so the bottom supporting rack 21 can rotate on the surface of the bottom seat 23.

In order to provide a function of circumrotating position limitation, the bottom plane of the bottom supporting rack 21 is downwardly and extrudingly provided with a tenon 216, with respect to the location of the arc-shaped position limiting slot 242, and the tenon 216 is received in the position limiting slot 242, so that the rotation of the bottom supporting rack 21 is limited. In order to generate a proper torque when the bottom supporting rack 21 and the bottom cover 25 rotate, a resilient member 26, e.g. a large disc resilient sheet, is provided between the retaining sheet 24 and the bottom cover 25, and wear-resistant rings 27 are respectively provided between the bottom supporting rack 21 and the retaining sheet 24 and between the bottom cover 25 and the retaining sheet 24 for reducing frictions. As shown in FIG. 2, the upper wear-resistant ring 27 is provided with a non-through gap 271 for letting the tenon 216 provided at the bottom plane of the bottom supporting rack 21 pass through; and the lower wear-resistant ring 27 is provided between the resilient member 26 and the bottom cover 25.

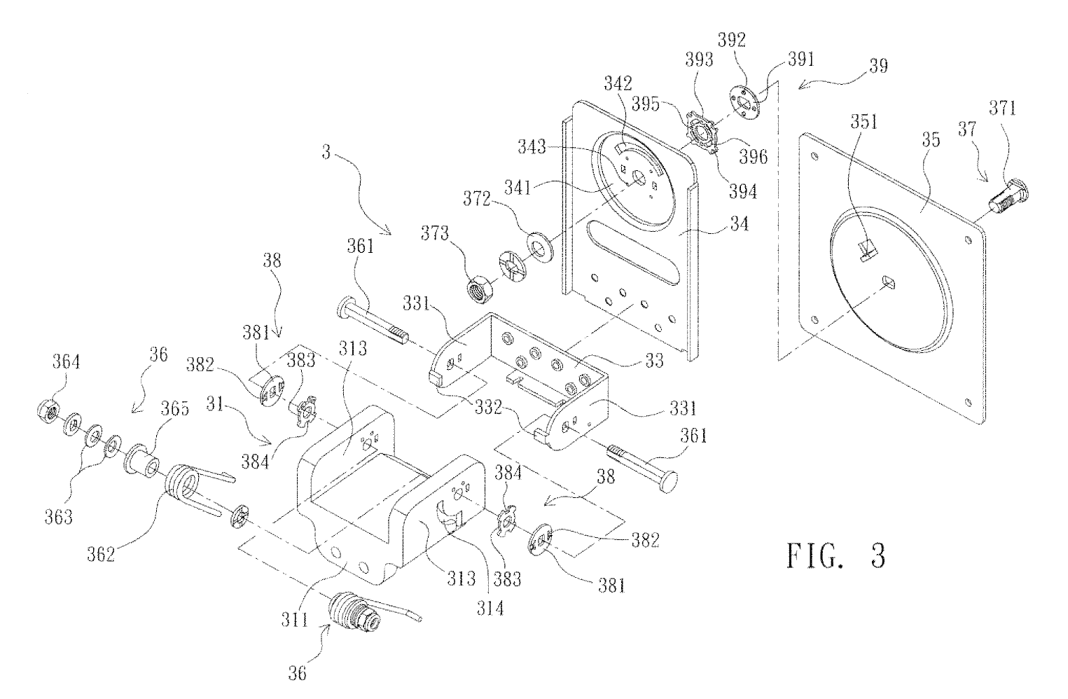

As shown in FIG. 3, the supporting device 3 is provided with a supporting member 31, two engaging sheets 311 at the bottom end of the supporting member 31 are pivotally connected to the top rotation sheet 11 of the pair of retracting devices 1. The difference between the supporting member 31 and a conventional supporting member is that after the supporting member 31 has been rotated 90 degree, the supporting member 31 and the supported object, e.g. a mounting plate 35 for connecting a flat panel monitor, are laterally disposed in relation to the pair of retracting devices 1, so a lateral opening/closing movement of the retracting device 1 generated during the height adjustment is prevented from being contact with the supported object. The top end of the supporting member 31 is provided with a pair of connecting arms 313 and an adjusting member 33 capable of elevating/declining swinging is disposed in between the pair of connecting arms 313, the adjusting member 33 is a U-shaped rack member and a retaining sheet 34 is connected to the front portion of the adjusting member 33, a mounting plate 35 is further pivotal provided to the front portion of the retaining sheet 34, and the mounting plate 35 is connected to an object to be supported, e.g. a flat panel monitor.

A pair of swinging arms 331 provided adjacent to the pair of connecting arms 313 is backwardly extended from the adjusting member 33, and at least one adjusting shaft rod 361 of an adjusting hinge 36 passes through one of the connecting arms 313, one of the swinging arms 331, at least one adjusting torsion spring 362 and at least one resilient member 363, e.g. a disc resilient sheet, then is connected to an end sealing member 364, e.g. an anti-loosing nut, in the inner side of the swinging arm 331, so the adjusting member 33 is provided with functions of up-down adjusting and stage-less positioning, relative to the supporting member 31. The at least one adjusting torsion spring 362 is sleeved at an outer side of a tube strut 365, and the tube strut 365 is served to allow the adjusting shaft rod 361 pass through, and two ends of the adjusting torsion spring 362 are respectively propped against the supporting member 31 and the adjusting member 33, so less effort is need to adjust elevation/declination angle. The periphery of the pair of connecting arms 313 is respectively and concavely provided with a pair of arc-shaped position limiting slots 314, and the pair of swinging arms 331 of the adjusting member 33 is inwardly and extrudingly provided with a pair of propping tenons 332, with respect to the position limiting slots 314, for limiting the angle of elevation/declination adjustment.

A buckling set 38 is further provided between the supporting member 31 and the adjusting member 33, in other words the adjusting shaft rod 361 is in sequence connected to a buckling ring 381 then a latching ring 383 provided at the outer end of the connecting arm 313 within the interval between the supporting member 31 and the adjusting member 33, the inner surface of the buckling ring 381 is extrudingly provided with a pair of ring tenons 382, and the periphery of the latching ring 383 is correspondingly provided with two sets of arc-shaped concave latching slots 384. When the adjusting member 33 backwardly rotates with the mounting plate 35, each of the ring tenon 382 of the buckling ring 381 crosses over a stopping edge of one of the latching slots 384 until latches into another latching slot 384, so with respect to the base seat 2 the mounting plate 35 and the retaining sheet 34 are in parallel, and the retaining sheet 34 is provided next to the pair of connecting arms 313 at two ends of the supporting member 31; so the distance between the supporting device 3 and the base seat 2 is significantly decreased also the volume and the transportation cost are reduced.

The retaining sheet 34 is connected to the front portion of the adjusting member 33, e.g. a screw passing through the bottom end of the retaining sheet 34 and fixing on the front portion of the adjusting member 33. In order to allow the supported object rotate, e.g. rotate from horizontal to vertical, a concave section 341 of the retaining sheet 34 is provided with a 90-degree arc-shaped position limiting slot 342, and a position limiting tenon 351 of the mounting plate 35 pivotally connected to the front portion of the retaining sheet 34 is received in the position limiting slot 342. A mounting hinge 37 is provided at the center of the retaining sheet 34 and the mounting plate 35, so the mounting plate 35 can rotate 90 degree with respect to the retaining sheet 34, thus the supported object can be rotated from horizontal to vertical or vice versa. As shown in figures, the mounting hinge 37 is that a mounting shaft rod 371 passes through the mounting plate 35, the center of the concave section 341 of the retaining sheet 34 then the mounting shaft rod 371 is connected to at least one resilient member 372 then is connected to an end sealing member 373, e.g. an anti-loosing nut.

A buckling set 39 is provided between the retaining sheet 34 and the mounting plate 35, a front portion of a rotary buckling sheet 391 is provided with a plurality of buckling tenons 392, and concave portions 394 respectively disposed at four corners of a retaining buckling sheet 393 are retained at a protruding tenons 343 correspondingly provided at the center of the back portion of the concave section 341 of the retaining sheet 34, the surface of the retaining buckling sheet 393 is provided with buckling holes 395 in relation to the buckling tenons 392, and two adjacent buckling holes 395 are respectively provided with an arc-shaped slot 396 that does not communicate with each other. The rotary buckling sheet 391 can rotate with the mounting plate 35, so when the buckling tenon 392 is moved from one buckling hole 395 to another buckling hole 395, a feeling of stage differentiation is obvious enough to inform a user the direction of the supported object is changed and positioned.

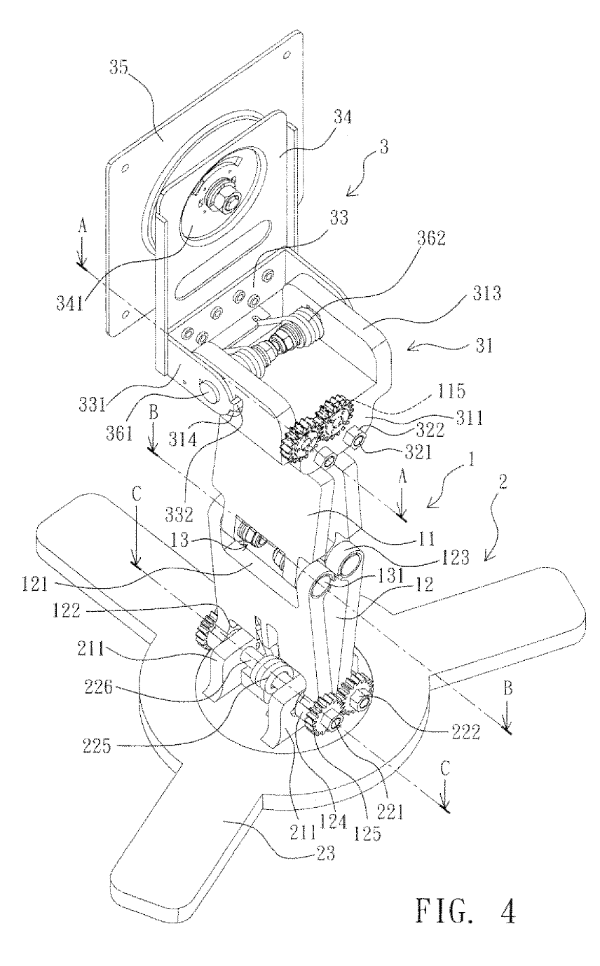

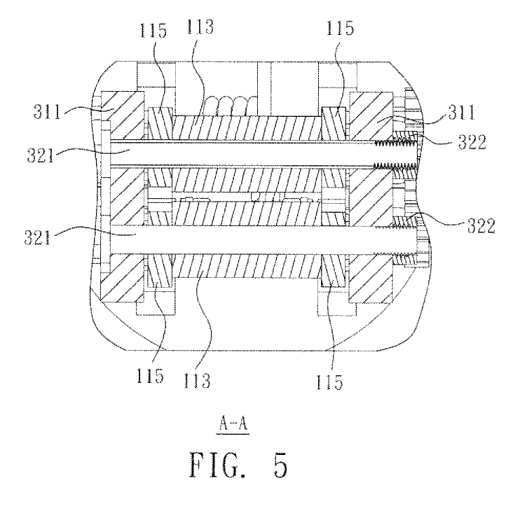

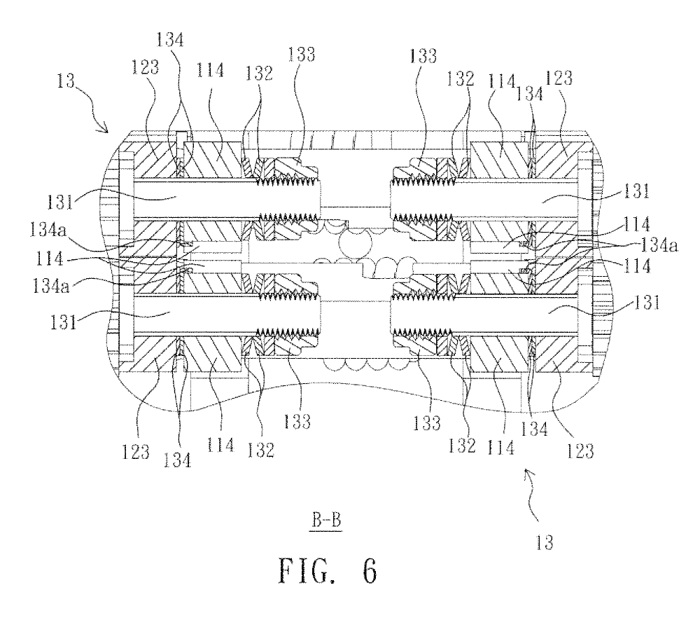

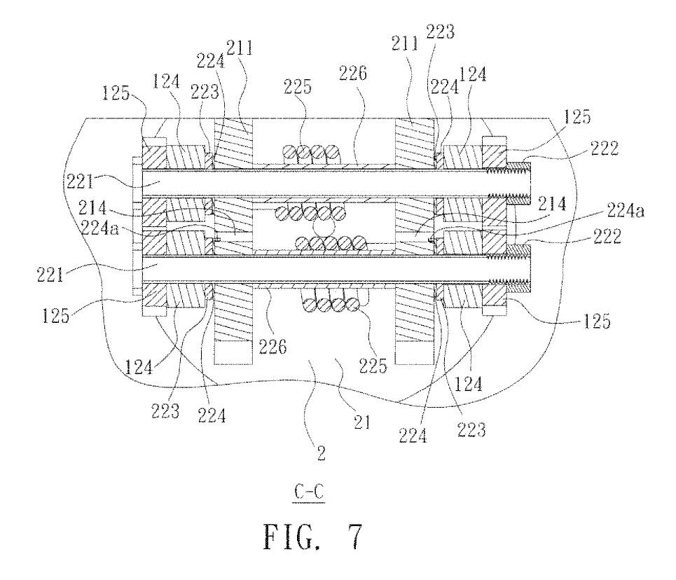

As shown in FIG. 4, which is a 3D view of a supporting structure composed by the pair of retracting devices 1, the base seat 2 and the supporting device 3 provided by the present invention, a propping section of the pair of retracting devices 1 is respectively and pivotally connected to the supporting member 31 of the supporting device 3 and the bottom supporting rack 21 of the base seat 2. The base seat 2 is disposed on a plane, e.g. a surface of a desk, and the mounting plate 35 is connected to an objected to be supported. As shown in FIG. 5 to FIG. 7, which are the cross sectional views of FIG. 4 intercepted alongside an A-A, a B-B and a C-C lines, which disclose the cross sectional view of the top rotation sheet 11 and the linking members 115 thereof and the supporting member 31, the cross sectional view of the top and the bottom rotation sheets 11, 12 and the pivotal connecting hinge 13, and the cross sectional view of the bottom rotation sheet 12 and the linking members 125 thereof and the bottom supporting rack 21. The first bottom lug 114 and the second top lug 123 disposed at one side of the middle portion of the pair of retracting devices 1 are propped against the other first bottom lug 114 and the other second top lug 123 disposed at the other side, so a tilting angle is formed, thus movements of the top and the bottom rotation sheets 11, 12 are prevented from moving to a dead point so the stretch and the contract of the pair of retracting devices 1 is facilitated.

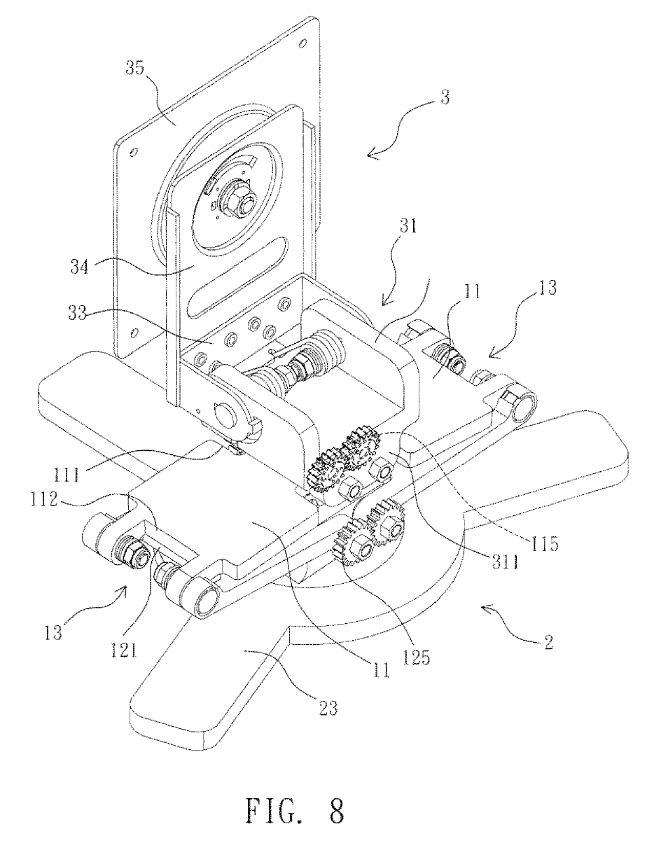

Referring to FIG. 4 and FIG. 8, if the height is desired to be adjusted, a force is only needed for applying to the object to be supported, so the linking members 115 disposed at two ends of the top end 111 of the top rotation sheet 11 are engaged and rotated in opposite directions, and the bottom end 112 of the top rotation sheet 11 and the top end 121 of the bottom rotation sheet 12 pivotally connected by the pivotal connecting hinge 13 are gradually and outwardly moved, so the linking members 125 disposed at two ends of the bottom end 122 of the bottom rotation sheet 12 are engaged and rotated in opposite directions, thus the pair of retracting devices 1 is in a contracting status for lowering the height, on the other hand, if the height is desired to be raised, the pair of retracting devices 1 is in a tilt stretching status.

The present invention has overcome disadvantages that when an elevation (height) adjustment is operated by a conventional supporting structure, a supported object will perform a fan-liked movement and a forward/backward movement is therefore formed; by applying a force to the pair of retracting devices, the elbow joint section disposed at a pivotal connecting location between the top and the bottom rotation sheets is inwardly or outwardly moved, thus the top and the bottom rotation sheets correspondingly close or away from each other, so it can be ensured that the height of the supported objected is vertically adjusted without occupying too much space; and the present invention provides a function of vertically elevating, so problems that a base seat has to be pivotally connected to at the rear portion due to the forward/backward movement of the supported object has overcome and the appearance of the base seat can be styled to enhance the artistic sensation.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A supporting structure capable of vertically elevating comprises:
a pair of retracting devices correspondingly provided, each of the retracting devices is pivotally connected by a pivotal connecting hinge at a location where a bottom end of a top rotation sheet and a top end of a bottom rotation sheet are joined, so an elbow joint section is formed at the pivotal connecting location, two ends of a top end of the top rotation sheet and two ends of a bottom end of the bottom rotation sheet are respectively provided with a linking member, each of the linking members is pivotally connected to a supporting member of a supporting device and a bottom supporting rack of a base seat and is engaged with the other linking members provided at two ends of the top end of the top rotation sheet and two ends of the bottom end of the bottom rotation sheet provided on the other adjacent retracting device so a link is obtained;
a base seat having a bottom supporting rack for pivotally connecting the two bottom rotation sheets provided at the bottom end of the pair of retracting devices, and two pairs of the linking members disposed thereunder rotate in opposite directions;
a supporting device having a supporting member for pivotally connecting the two top rotation sheets provided on the top end of the pair of retracting devices and two pairs of the linking members thereon rotate in opposite directions;
so when applying a force to the pair of retracting devices, the elbow joint section located at the pivotal connecting location between the top and the bottom rotation sheets can move outwardly or inwardly so that the top and the bottom rotation sheets correspondingly close or away from each other for adjusting height.

2. The supporting structure capable of vertically elevating as claimed in claim 1, wherein each of the linking members is a gear integrally provided at two ends of the top end of the top rotation sheet and two ends of the bottom end of the bottom rotation sheet.

3. The supporting structure capable of vertically elevating as claimed in claim 1, wherein each of the linking members is a gear sleeved by a sleeving member for mounting on two ends of the top end of the top rotation sheet and two ends of the bottom end of the bottom rotation sheet.

4. The supporting structure capable of vertically elevating as claimed in claim 1, wherein the top end and the bottom end of the top rotation sheet are a first top lug and a pair of first bottom lugs, and the top end and the bottom end of the bottom rotation sheet are a pair of second top lugs and a pair of second bottom lugs; the pair of first bottom lugs and the pair of second top lugs are pivotally connected by a pivotal connecting hinge, and two adjacent lugs are passed through by an interposing rod that is in sequence connected with at least one resilient member at one side of a lug and is connected to an end sealing member.

5. The supporting structure capable of vertically elevating as claimed in claim 4, wherein a wear-resistant ring is provided between the first bottom lug and the adjacent second top lug, and the periphery of the wear-resistant ring is axially and extrudingly provided with a lug sheet for mounting into each pre-set lug slots provided at the periphery of the first bottom lug and the second top lug.

6. The supporting structure capable of vertically elevating as claimed in claim 1, wherein two engaging sheets are longitudinally and extrudingly provided at the bottom end of the supporting member so the top rotation sheet of the pair of retracting devices and the linking members thereof can be received in between the two engaging sheets, then a supporting shaft rod of a supporting hinge is provided and passing through rod holes correspondingly provided on the two engaging sheets and through the top rotation sheet and the two linking members, then is connected to an end sealing member.

7. The supporting structure capable of vertically elevating as claimed in claim 6, wherein a wear-resistant ring is provided between each of the linking members and the corresponding inner wall of the engaging sheets.

8. The supporting structure capable of vertically elevating as claimed in claim 1, wherein two connecting sheets are longitudinally and extrudingly provided at the bottom end of the bottom supporting rack of the base seat, and the bottom rotation sheet of the pair of retracting devices and the linking members thereof are received in between the two connecting sheets, a supporting rack shaft rod of a supporting rack hinge is provided and passing through rod holes correspondingly provided on the two connecting sheets and through the bottom rotation sheet and the two linking members, then is connected to an end sealing member.

9. The supporting structure capable of vertically elevating as claimed in claim 8, wherein the peripheries of the shaft holes of the two connecting sheets of the bottom supporting rack are respectively provided with an arc-shaped angle limiting slot, and the supporting rack shaft rod is provided with a position limiting sheet linked with the angle limiting slot at each outer end of the two connecting sheets, the periphery of each of the two position limiting sheets is axially and extrudingly provided with a tenon that is received within the corresponding angle limiting slot for limiting the rotation of the bottom rotation sheet linked and simultaneously operated with the supporting rack shaft rod.

10. The supporting structure capable of vertically elevating as claimed in claim 9, wherein a wear-resistant ring is provided between each of the position limiting sheets and the connecting sheets, the periphery of the wear-resistant ring is axially and extrudingly provided with a tenon sheet for mounting into each pre-set tenon holes provided at the periphery of the rod holes of the connecting sheets.

11. The supporting structure capable of vertically elevating as claimed in claim 1, wherein the base seat is further provided with a bottom seat, the center of the bottom seat is provided with a multi-stepped through hole, a retaining sheet is provided within the through hole, and a bottom cover and the bottom supporting rack are joined within the through hole for clamping the retaining sheet, so the bottom supporting rack can rotate on the surface of the bottom seat.

12. The supporting structure capable of vertically elevating as claimed in claim 11, wherein an arc-shaped position limiting slot is outwardly extended from a periphery of a sheet hole disposed at the center of the retaining sheet, the bottom plane of the bottom supporting rack is downwardly and extrudingly provided with a tenon, with respect to the location of the arc-shaped position limiting slot, and the tenon is received in the arc-shaped position limiting slot.

13. The supporting structure capable of vertically elevating as claimed in claim 11, wherein a resilient member is provided between the retaining sheet and the bottom cover.

14. The supporting structure capable of vertically elevating as claimed in claim 11, wherein a wear-resistant ring is respectively provided between the bottom supporting rack and the retaining sheet and between the bottom cover and the retaining sheet.

15. The supporting structure capable of vertically elevating as claimed in claim 1, wherein a pair of connecting arms is provided on top end of the supporting member of the supporting device and an adjusting member capable of elevation/declination swinging is disposed in between, a retaining sheet is provided to the front portion of the adjusting member, a mounting plate is further pivotally connected to the front portion of the retaining sheet, and the mounting plate is laterally disposed with respect to the pair of retracting devices.

16. The supporting structure capable of vertically elevating as claimed in claim 15, wherein a pair of swinging arms provided adjacent to the pair of connecting arms of the supporting member is backwardly extended from the adjusting member, and an adjusting shaft rod of an adjusting hinge is provided and passing through the pair of connecting arms, the pair of swinging arms, and at least one adjusting torsion spring between the two arms, and is connected to an end sealing member at one side of one of the swinging arms, and two ends of the adjusting torsion spring are respectively propped against the supporting member and the adjusting member.

17. The supporting structure capable of vertically elevating as claimed in claim 16, wherein the periphery of the pair of connecting arms is concavely provided with an arc-shaped position limiting slot, and the pair of swinging arms of the adjusting member is inwardly and extrudingly provided with a pair of propping tenons, with respect to the position limiting slot, for limiting the angle of elevation/declination adjustment.

18. The supporting structure capable of vertically elevating as claimed in claim 15, wherein a retaining sheet provided with an arc-shaped position limiting slot is connected to the front portion of the adjusting member, a mounting plate pivotally connected to the front portion of the retaining sheet is inwardly provided with a position limiting tenon with respect to the position limiting slot and the position limiting tenon is received in the position limiting slot; the retaining sheet and the mounting plate are pivotally connected by a mounting hinge, a mounting shaft rod is provided and passing through the center of the retaining sheet and the mounting plate and is connected with at least one resilient member then is connected to an end sealing member.

19. The supporting structure capable of vertically elevating as claimed in claim 15, wherein a buckling set is provided between the supporting member and the adjusting member and the buckling set is composed by a buckling ring and a latching ring disposed at the outer end of the connecting arm, and the two rings are served to let the adjusting shaft rod pass through; the inner surface of the buckling ring is extrudingly provided with a pair of ring tenons and the periphery of the latching ring is correspondingly provided with two sets of arc-shaped concave latching slots; when the adjusting member backwardly rotates with the mounting plate, each ring tenon of the buckling ring crosses over a stopping edge of the latching slot until latches into another latching slot, so with respect to the supporting member, the mounting plate and the retaining sheet are in parallel.

20. The supporting structure capable of vertically elevating as claimed in claim 15, wherein a buckling set is provided between the retaining sheet and the mounting plate, a front portion of a rotary buckling sheet is provided with a plurality of buckling tenons, and concave portions respectively disposed at four corners of a retaining buckling sheet are retained at a protruding tenons correspondingly provided at the center of the back portion of the concave section of the retaining sheet, the surface of the retaining buckling sheet is provided with buckling holes in relation to the buckling tenons, and two adjacent buckling holes are respectively provided with an arc-shaped slot that does not communicate with each other; when the retaining buckling sheet can rotate with the mounting plate, the buckling tenon is moved from one buckling hole to another buckling hole, a feeling of stage differentiation is thus obvious.
